(19) United States
(12) Patent Application Publication
(10) Pub. No.: US 2008/0121578 A1
(43) Pub. Date: May 29, 2008

(54) AUTOMATIC COOKING MEDIUM FILTERING SYSTEMS AND METHODS

(75) Inventors: Douglas A. Burkett, Eaton, OH (US); Tim A. Landwehr, West Alexandria, OH (US); Robert W. Stirling, Dayton, OH (US); Joseph J. Tiszai, Fairfield, OH (US); Robert T. Wood, Tipp City, OH (US)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: HENNY PENNY CORPORATION, Eaton, OH (US)

(21) Appl. No.: 11/563,597

(22) Filed: Nov. 27, 2006

(51) Int. Cl. A47J 37/12; B01D 35/027

(52) U.S. Cl. 210/167.28; 210/767; 99/408

(57) ABSTRACT

An automatic, or “one touch,” filtering system for filtering a cooking medium in a cooking apparatus, e.g., a fryer, includes a cooking vessel, e.g., a frypot; a drain valve disposed on a drain path between the cooking vessel and a filter container; a fill valve disposed on a fill path between the filter container and the cooking vessel; a pump disposed on one of the first path and the second path for conveying the cooking medium from the drain path to the fill path through the filter container; a controller configured to selectively operate the drain valve and the fill valve to regulate a flow of cooking medium to and from the cooking vessel; and a single switch configured to send a control signal to the controller in response to actuating the switch. The systems and methods of the invention provide automatic filtering that may reduce or eliminate incorrect valve operation, so that the filtering process may be performed correctly each time.

### BACKGROUND OF THE INVENTION

1. Field of the Invention

The present invention relates generally to systems and methods for automatically filtering a cooking medium in a cooking apparatus, such as a fryer.

2. Description of Related Art

Known fryers, e.g., open-well fryers and pressure fryers, are used to cook various food products, e.g., poultry, fish, or potato products. Such fryers include a cooking vessel, e.g., a frypot, and the cooking vessel is filled with a cooking medium, e.g., an oil, a liquid shortening, or a meltable-solid shortening. Such fryers also include a heating element, e.g., an electrical heating element, such as a heating coil, or a gas heating element, such as a gas burner and gas conveying tubes, which heat the cooking medium in the cooking vessel. After the cooking medium reaches a preset cooking temperature, the food product is placed into the cooking medium, such that the food product is cooked in the cooking medium. For example, the food product may be positioned inside a product holder, e.g., a wire basket, and submerged in the cooking medium for a predetermined amount of time sufficient to cook or to complete the cooking of the food product. The amount of time sufficient to cook or to complete the cooking of the food product at a given cooking temperature depends on the type of food product which is cooked. Moreover, the cooking medium is used during several cooking cycles before the cooking medium inside the cooking vessel is filtered, replaced, or supplemented with a new or filtered supply of cooking medium.

Cooking medium may be filtered periodically to maintain cooking quality and to prolong the operational lifetime of the cooking medium. The filtering process removes cooking by-product, e.g., suspended food particles, ranging from dust-sized particles to larger pieces of crackling and small pieces of food product. Known contemporary filtering systems require the operator to manipulate manual valves to route the cooking medium through the filter and to return it to a cooking vessel, e.g., a frypot, disposed within the fryer. Even experienced operators may open or close the valves incorrectly, which increases operating expenses through lost time. Periodically, the drain pan under the fryer may be removed for cleaning or to discard the cooking medium. If the operator forgets to replace the drain pan and opens the drain valve, the cooking medium drains onto the floor and be wasted, which greatly increases operating expenses. Moreover, it is desirable to filter the cooking medium for an appropriate time period. If the filter time is too short, the cooking medium may not be not adequately filtered. If the filter time is too long, operating efficiency is impaired, and cooking medium quality may be unnecessarily degraded by mechanical agitation and oxidation.

In addition, multiple frypots may be connected to a single drypan. Each frypot may be designated for cooking a different food product, e.g., chicken, french-fried potatoes, and fish. The flavor characteristics of each of these food products may become infused in the cooking medium. As a result, mixing cooking medium from frypots designated for different food products during filtering may adversely affect food quality, e.g., cooking chicken in a significant quantity of fish flavored cooking medium may result in “fishy” chicken. A manual filtering system may permit an operator to simultaneously filter cooking medium for frypots designated for different food products, which may reduce the quality of cooked food product for the reasons noted above.

Referring to FIGS. 1 and 2, a fryer apparatus 10 comprising a known manual cooking medium filtering system and a known method for operating such a filtering system are depicted. Fryer apparatus 10 includes a frypot 16 having an open top 14 for receiving a food product. A cabinet 20, shown without a door for illustrative purposes, has brackets 32 supporting a drain pan 30 having a filter (not shown). Drain pan 30 includes a handle 34 that allows drain pan 30 to be removed from cabinet 20 for cleaning. Drain pan 30 is fluidly connected to frypot 16 via a drain hose 24 and a filter pipe 28. Disposed on filter pipe 28 is a filter pump 27 for drawing cooking medium to frypot 16 from pan 30. Frypot 16 includes a drain valve handle 22 that operates a drain valve (not shown) for selectively permitting cooking medium to drain from frypot 16 via hose 24. Frypot 16 also includes a filter valve handle 26 that operates a filter valve (not shown) for selectively permitting the introduction of cooking medium to frypot 16 from drain pan 30. Fryer apparatus 10 further may include a power supply 40 for powering filter pump 27, which may be actuated via a switch on control panel 18.

Referring to FIG. 2, a method for operating a known filtering system is depicted. To filter the cooking medium of fryer apparatus 10, the operator first ensures that the filter valve is closed 50. The operator turns drain valve handle 22 clockwise to manually open the drain valve 55, which uses gravity to permit the cooking medium to drain into drain pan 30. Next, the operator turns the filter valve handle 26 counter-clockwise to manually open the filter valve 60. The operator then turns drain valve handle 22 counter-clockwise to manually close the drain valve 55. The operator then actuates filter pump 70 using a switch that may be located on control panel 18. Next, the operator de-actuates the filter pump 75 to end the filtering process. Finally, the operator turns filter valve handle 26 in a clockwise direction to manually close the filter valve 80, so that operation of the fryer apparatus may resume.

Handles 22, 26 may be located in cabinet 20 beneath frypot 16, and may not be clearly marked. The above-described procedure is not intuitive unless the operator understands the logic and plumbing of the filter system, which generally is not the case for untrained operators. In known filtering systems, handles 22, 26 may be turned opposite directions to achieve the same result, in part because of design limitations within cabinet 20, which may add another element of complexity that may lead to operator error. Further, if one of the sequence of steps is omitted or executed out of order, then, at best, the operating efficiency of the fryer apparatus is impaired, and, at worst, the pump or frypot may be damaged. Even trained, experienced operators may omit or switch steps during the rush of peak cooking periods, e.g., the “lunch-rush.”

### SUMMARY OF THE INVENTION

Therefore, a need has arisen for filtering systems and methods for a cooking apparatus that overcome these and other shortcomings of the related art. A technical advantage of the present invention is that automatic filtering prevents incorrect valve operation, so that the filtering process is performed substantially correctly each time. Another technical advantage of the invention is that operating profits may be increased by reducing the personnel training needed by providing a “one-touch filtering” system where the operator need only actuate a single switch to accomplish filtering. Yet another technical advantage of the invention is that precise control of the filtering cooking medium may be achieved. Still another technical advantage of the invention is that mixing of significant amounts of cooking medium from frypots used to cook different food products, which may adversely affect cooked food product quality, may be reduced or eliminated.

The systems and methods of the invention are suitable for use with automatic cooking medium level control systems and methods, such as those disclosed in the nonprovisional patent application, Attorney Docket No. 018853.0773, filed on Nov. 27, 2006, entitled “AUTOMATIC OIL LEVEL CONTROL SYSTEMS AND METHODS,” the disclosure of which is hereby incorporated by reference in its entirety.

According to an embodiment of the present invention, a method for automatically filtering a cooking medium of a cooking apparatus comprises the steps of requesting filtering of the cooking medium; determining whether the cooking medium in a cooking vessel of the cooking apparatus is in suitable condition for filtering in response to the filtering request; and filtering the cooking medium in the cooking vessel upon the determination that the cooking medium in the cooking vessel is in suitable condition for filtering. The filtering step further comprises the steps of: opening a drain valve for draining the cooking medium from the cooking vessel; opening a fill valve for introducing the cooking medium to the cooking vessel before closing the drain valve; draining the cooking medium from the cooking vessel; passing the cooking medium through a filter; introducing the filtered cooking medium into the cooking vessel; closing the drain valve before closing the fill valve; and closing the fill valve.

According to another embodiment of the present invention, a system for automatically filtering a cooking medium of a cooking apparatus comprises: a first cooking vessel; a first drain valve disposed on a first fluid communication path between the first cooking vessel and a drain manifold; a filter container having fluidly connected to the drain manifold on a manifold drain path; a fill manifold fluidly connected to the filter container on a manifold fill path; a first fill valve disposed on a second fluid communication path between the fill manifold and the first cooking vessel; a pump for conveying the cooking medium from the drain path to the fill path through the filter container; a controller configured to selectively operate the first drain valve and the first fill valve to regulate a flow of cooking medium to and from the first cooking vessel; and a single switch configured to send a control signal to the controller upon actuation of the switch.

According to yet another embodiment of the invention, a system for automatically filtering a cooking medium of a cooking apparatus comprises a cooking vessel; a drain valve disposed on a first fluid communication path between the cooking vessel and a filter container; a fill valve disposed on a second fluid communication path between the filter container and the cooking vessel; a pump disposed on one of the first path and the second path for conveying the cooking medium from the first path to the second path through the filter container; a controller configured to selectively operate the drain valve and the fill valve to regulate a flow of cooking medium to and from the cooking vessel; and a single switch configured to send a control signal to the controller in response to actuating the switch.

According to still yet another embodiment of the invention, a system for automatically filtering a cooking medium of a cooking apparatus comprises means for requesting filtering of the cooking medium; means for determining whether the cooking medium in a cooking vessel of the cooking apparatus is in suitable condition for filtering; means for filtering the cooking medium in the cooking vessel upon a determination that the cooking medium in the cooking vessel is in suitable condition for filtering; and means for indicating one of the means for filtering is operating and the cooking medium is not suitable for filtering. The means for filtering further comprises a drain valve means for operating a drain valve for draining the cooking medium from the cooking vessel; a fill valve means for operating a fill valve for introducing the cooking medium to the cooking vessel; means for draining the cooking medium from the cooking vessel; means for passing the cooking medium through a filter; and means for introducing the filtered cooking medium into the cooking vessel.

Other objects, features, and advantages of the present invention will be apparent to persons of ordinary skill in the art in view of the foregoing detailed description of the invention and the accompanying drawings.

### BRIEF DESCRIPTION OF THE DRAWINGS

For a more complete understanding of the present invention, needs satisfied thereby, and the objects, features, and advantages thereof, reference now is made to the following description taken in connection with the accompanying drawings.

FIG. 1 is a front view of a fryer apparatus utilizing a known manual filtering system.

FIG. 2 is a flow chart showing a known method for operating the filter system shown in FIG. 1.

FIG. 3 is a schematic view of an automatic cooking medium filtering system according to an embodiment of the invention.

FIG. 4A is a perspective view of a cooking vessel according to an embodiment of the invention.

FIG. 4B is a plan view of a cooking vessel according to another embodiment of the invention.

FIG. 5 is a schematic view of an automatic cooking medium filtering system according to another embodiment of the invention

FIG. 6 is a flow chart showing a method for automatically filtering a cooking medium according to an embodiment of the invention.

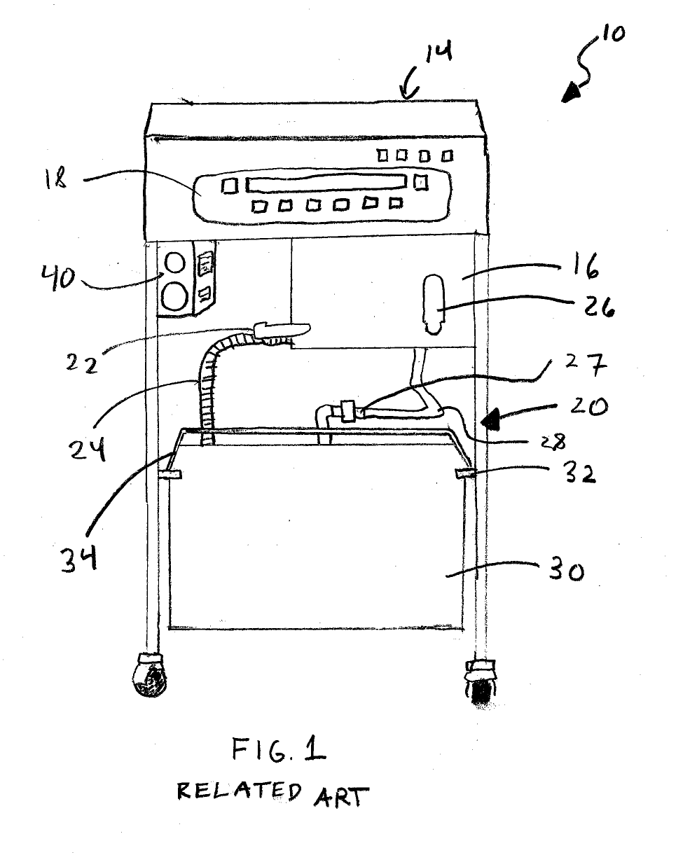

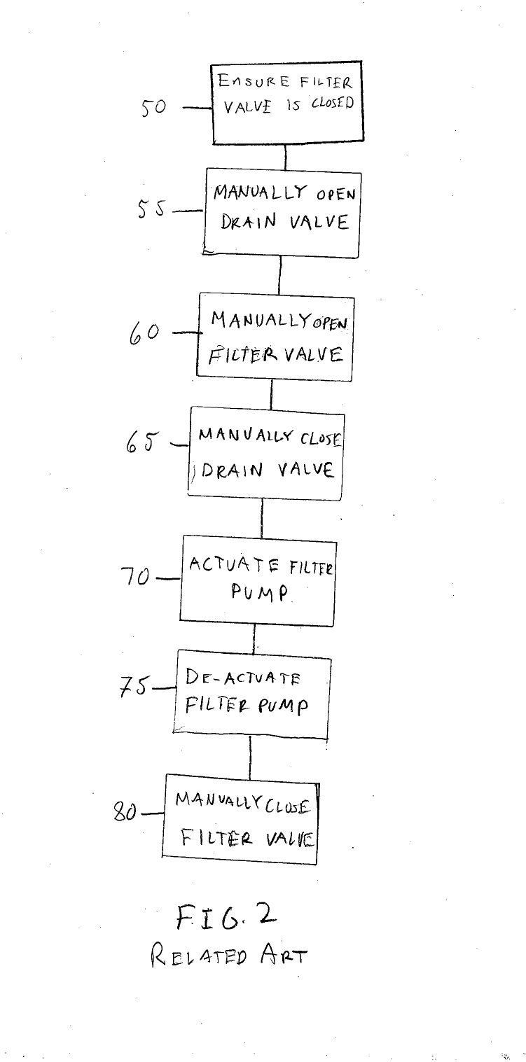

### DETAILED DESCRIPTION OF THE INVENTION

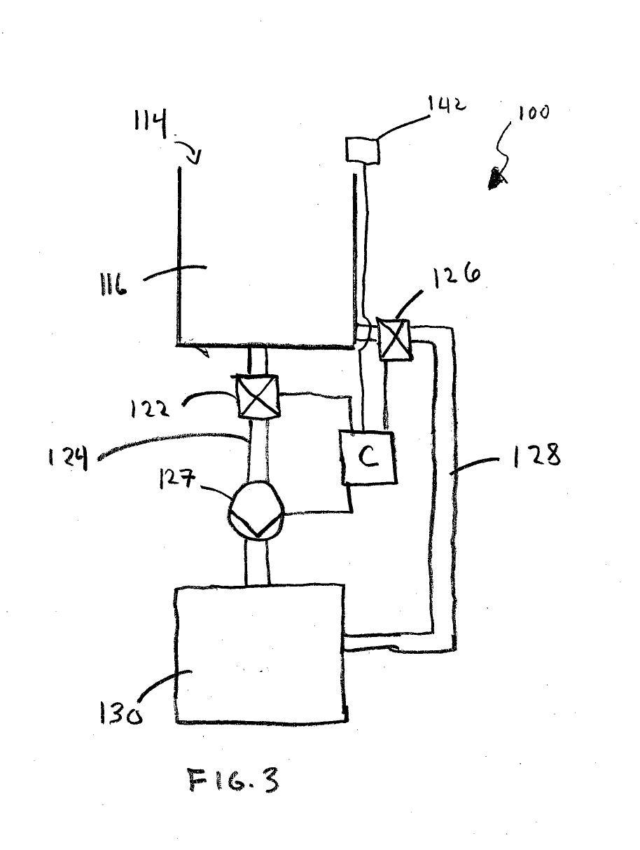

Preferred embodiments of the present invention, and their features and advantages, may be understood by referring to FIGS. 3-6, like numerals being used for corresponding parts in the various drawings.

Referring to FIG. 3, a filtering system 100 according to an embodiment of the present invention is depicted. Fryer apparatus 100 may comprise at least one cooking vessel 116, e.g., a frypot, which may be configured to hold a cooking medium, e.g., an oil, a liquid shortening, a meltable-solid shortening, or the like. Cooking vessel 116 may include an opening 114 for receiving a food product. A heating element (not shown), which may be a heating coil, is disposed within cooking vessel 116 for heating the cooking medium within vessel 116. Filtering apparatus 100 may be utilized in a gas or electric fryer appartus. FIG. 3 depicts vessel 116 suitable for an open-well fryer, but filtering system 100 also be used in a pressure fryer.

Cooking vessel 116 may comprise a drain at an inlet of a drain path 124 fluidly connecting vessel 116 to a filter container 130, e.g., a drain pan or a filter canister. A drain valve 122, which may be a solenoid valve, may be disposed on drain path 124 to selectively permit cooking medium to drain from vessel 116 in response to a control signal from a controller C. Preferably, drain valve 122 is a linearly actuated valve to reduce the likelihood that cooking by-product may obstruct valve 122. Cooking medium may pass through filter container 130 and return to vessel 116 via a filter or a fill path 128. A second filter container (not shown) that may serve as a backup filter also may be connected to paths 124, 128, when a filter in container 130 requires replacing or otherwise malfunctions. A filter or a fill valve 126, which also may be a solenoid valve, may be disposed on filter path 124 to selectively permit cooking medium to be intoduced into vessel 116 in response to a control signal from controller C.

Referring to FIG. 3, a pump 127 is disposed on drain path 124 to convey the cooking medium along drain and fill paths 124, 128, but pump 127 also may be disposed on fill path 128. Pump 127 actuates and de-actuates in response to a control signal from controller C. Controller C may comprise a processor coupled to a physical memory, an operator input, e.g., a push-button manual switch or an electronic switch, and a mechanism to detect whether the cooking medium is in suitable condition for filtering. Controller C may be coupled to an indicator 142, e.g., a visual or audible alarm that indicates either that a filtering process is being performed by system 100 or that the cooking medium in vessel 116 is not in suitable condition for filtering. Indicator 142 may be a light, e.g., incandescent, fluorescent, LED, or the like, or indicator 142 may be incorporated into the fryer apparatus' current display, such as on an LCD screen. If indicator 142 is an LED light, it may be on to indicate filtering of the cooking medium, and may blink to indicate the cooking medium is not suitable, i.e., not ready for, filtering.

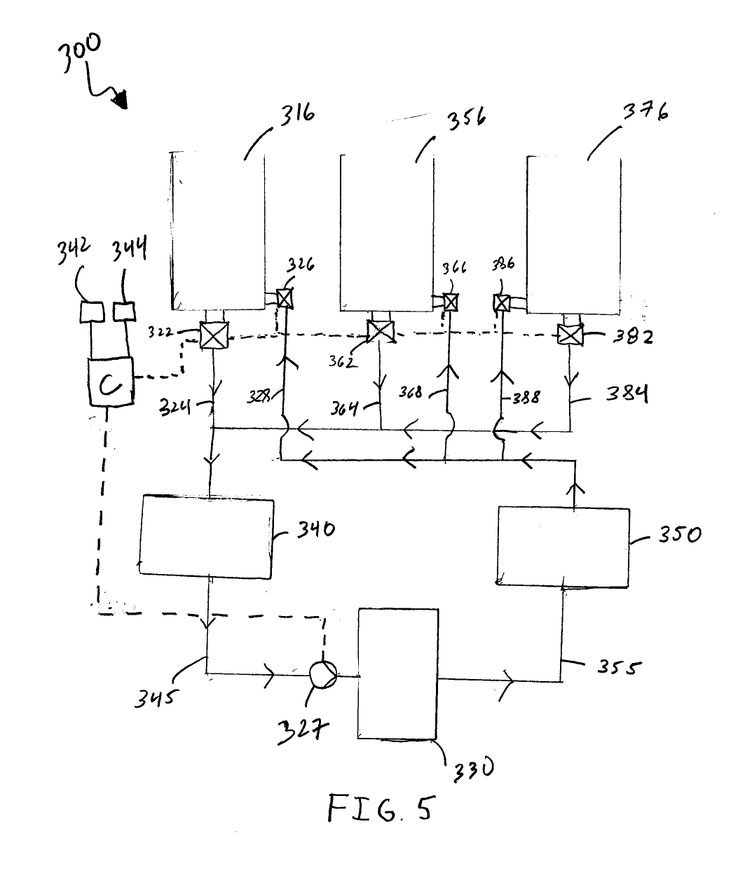

Drain and fill manifolds (not shown) may be disposed on the respective drain and fill paths, such an arrangement may permit the use of a smaller filter container that has an insufficient capacity to hold the entire volume of cooking medium within vessel 116, or may allow multiple vessels to be connected to the same filter container wherein a multiple vessel, fryer apparatus may use a single filtering system, as shown, for example, in FIG. 5.

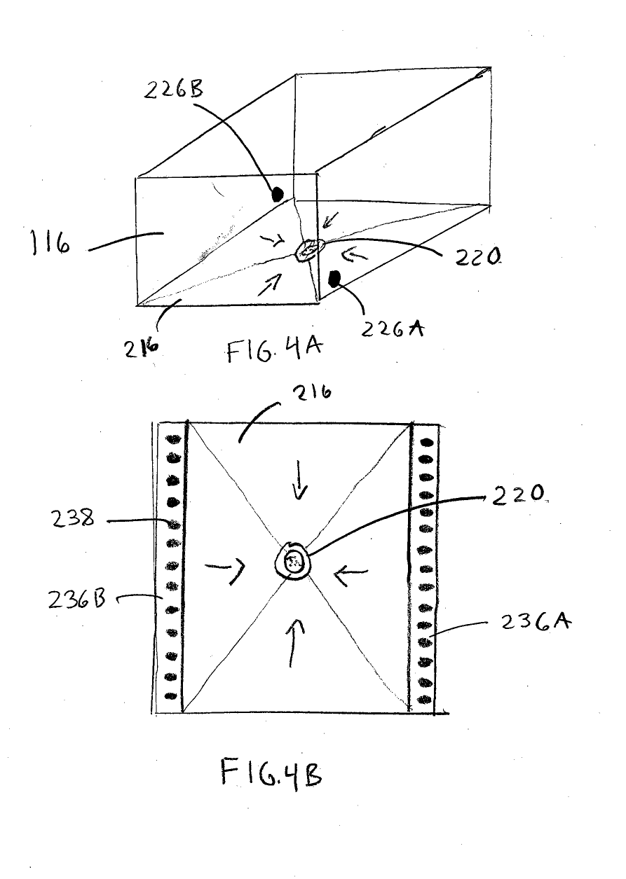

Referring to FIG. 4A and FIG. 4B, arrangements for cooking medium inlets fluidly connected to filter path 128 according to embodiments of the invention are depicted. As shown in FIG. 4A, a pair of inlets 226A, 226B may be formed within a surface of cooking vessel 116 disposed at opposite ends of a longitudinal axis, i.e. a length, of vessel 116. For example, here inlets 226A, 226B are shown as formed within opposing sidewalls of vessel 116. Inlets 226A, 226B may be separated by a lateral distance that is substantially a width of vessel 116. Arranging inlets 226A, 226B in this configuration may facilitate “swirling” of the cooking medium on a bottom surface 216 of vessel 116 to clean bottom surface 216, wherein cooking by-product or any other particles may exit vessel 116 through a drain 220. Bottom surface 216 may be sloped towards drain 220 to assist cooking medium, and any cooking by-product therein, to exit vessel 116. Preferably, inlets 226A, 226B are disposed proximate bottom surface 216.

Referring to FIG. 4B, an alternative inlet arrangement is depicted. A pair of linear diffuser headers 236A, 236B may extend along opposing sides of bottom surface 216. Diffuser headers 236A, 236B also may be disposed on opposing sidewalls of vessel 116 proximate to the bottom surface 216. Preferably, diffuser headers 236A, 236B extend substantially parallel to a longitudinal axis, i.e., along a length, of vessel 116. Diffuser headers 236A, 236B may comprise a plurality of inlet holes 238 for introducing cooking medium via filter path 128. Preferably, inlet holes 238 are configured to direct cooking medium towards a center axis of bottom surface 216 to promote the swirling of cooking medium for the reasons described above. Again, bottom surface 216 may be sloped towards drain 220.

Referring to FIG. 5, a filtering system 300 according to another embodiment of the present invention is depicted. A filtering system may comprises a plurality of cooking vessels 316, 356, 376, e.g., frypots. Each vessel 316, 356, 376 may comprise a drain path 324, 364, 384 fluidly connected to a common, drain manifold 340. If two vessels, e.g., vessels 316 and 356, are designated for a same first food product, and the third vessel, e.g., vessel 376, is designated for a different second food product, then vessels 316, 356 may be fluidly connected to a first drain manifold, while vessel 376 may be fluidly connected to a second drain manifold to segregate further the flavors infused in the cooking mediums for the respective first and second food products. A drain valve 322, 362, 382 responsive to a control signal from controller C may be disposed in each drain path 324, 364, 384.

Drain manifold 340 may be connected fluidly to filter container 330 on a manifold drain path 345. An outlet (not shown) a filter container 330 may be fluidly connected to a filter or a fill manifold 350 through a manifold filter or fill path 355. A pump 327 may be disposed on either manifold path 345, 355 to draw cooking medium through filter container 330. Here, pump 327, which may be responsive to a control signal from controller C, is shown as disposed on manifold drain path 345. Filter manifold 350 may be fluidly connected to each vessel 316, 356, 376 via a respective filter path 328, 368, 388. A filter valve 326, 366, 386 responsive to a control signal from controller C may be disposed on each filter path 326, 366, 386.

Controller C may be actuated by an operator using a single switch 344, e.g., a mechanical or an electronic switch. An indicator 342 coupled to controller C may give a visual or audible indication that filtering of cooking medium from at least one vessel 316, 356, 376 is being performed, or that the cooking medium in at least one of the vessels is not suitable, i.e., not ready, for filtering. Indicator 342 may also indicate that the cooking medium needs filtering, such indication may be based on a predetermined number of cooking cycles for which the cooking medium has been used or sensing the condition of the cooking medium to determine that it is no longer suitable or efficient for cooking food product.

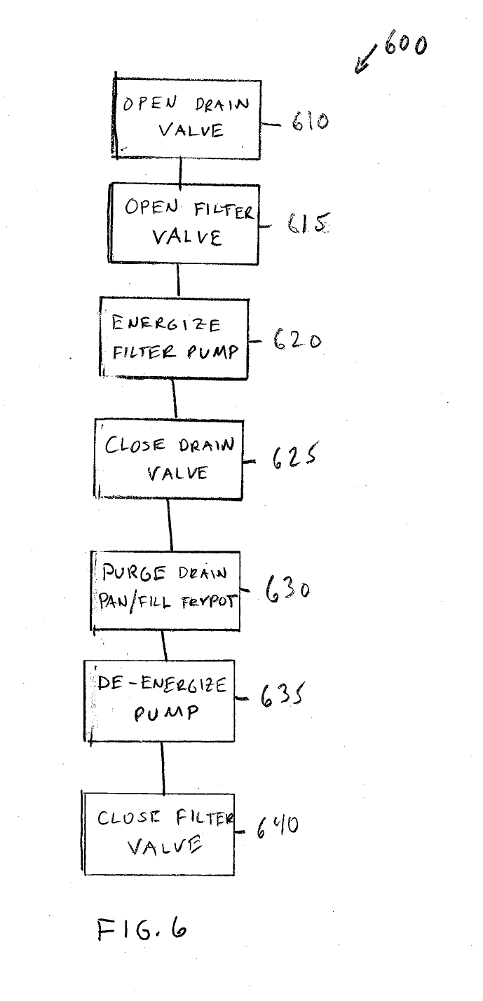

Referring to FIG. 6, a method for automatically filtering a cooking medium of a cooking vessel, e.g., a frypot, is depicted. First, the operator may request the cooking medium in a cooking vessel to be filtered, e.g., by actuating a switch. Next, a controller may determine whether the cooking medium in the vessel is suitable, i.e., ready, for filtering. Parameters used for determining whether the cooking medium is ready for filtering may include, but are not limited to, the temperature of the cooking medium, any turbulence detected in the cooking medium, or whether food product is within the vessel. Further, if the method is used with a fryer apparatus having a plurality of cooking vessels, not more than one vessel may be suitable for filtering at any time, so that multiple vessels will not be filtered concurrently, in part, to prevent mixing of a significant amount of cooking medium from different vessels. Once it is determined that the cooking medium is suitable for filtering, then filtering of the cooking medium may begin.

Referring to FIG. 6, a method 600 for automatically filtering the cooking medium according to one embodiment of the invention is depicted. First, in step 610, a drain valve may be automatically opened to permit cooking medium to exit, or drain, the cooking vessel. Next, in step 615, a filter valve may be automatically opened to permit introduction of cooking medium into the vessel. Subsequently, a filter pump may be energized in step 620 to pass the cooking medium through a container, such as a drain pan or filter canister, to filter the cooking medium. Both the drain valve and the filter valve may be open concurrently when the pump is energized to enable a flow of cooking medium to coat or swirl on a bottom surface of the cooking vessel for cleaning purposes. After letting the cooking medium “clean” the bottom surface of the vessel for a predetermined period, the drain valve may be closed automatically in step 625 to allow purging of the filter container and filling of the vessel with cooking medium in step 630. Next, the pump may be de-energized in step 635 after filling the vessel. Finally, the filter valve may be closed automatically in step 640 to prevent drainage of cooking medium into the filter container and complete the filtering of cooking medium from the cooking vessel.

While the invention has been described in connection with preferred embodiments, it will be understood by those of ordinary skill in the art that other variations and modifications of the preferred embodiments described above may be made without departing from the scope of the invention. Other embodiments will be apparent to those of ordinary skill in the art from a consideration of the specification or practice of the invention disclosed herein. The specification and the described examples are considered as exemplary only, with the true scope and spirit of the invention indicated by the following claims.

What is claimed is:

1. A method for automatically filtering a cooking medium of a cooking apparatus, comprising the steps of:
requesting filtering of the cooking medium;
determining whether the cooking medium in a cooking vessel of the cooking apparatus is in suitable condition for filtering in response to the filtering request; and
filtering the cooking medium in the cooking vessel upon the determination that the cooking medium in the cooking vessel is in suitable condition for filtering, the filtering step comprising the substeps of:
opening a drain valve for draining the cooking medium from the cooking vessel;
opening a fill valve for introducing the cooking medium to the cooking vessel before closing the drain valve;
draining the cooking medium from the cooking vessel;
passing the cooking medium through a filter;
introducing the filtered cooking medium into the cooking vessel;
closing the drain valve before closing the fill valve; and
closing the fill valve.

2. The method of claim 1, wherein the filtering step further comprises the substep cleaning a bottom surface of the cooking vessel, the cleaning substep comprises concurrently draining and introducing cooking medium, while both the drain valve and the fill valve are open.

3. The method of claim 2, wherein filtering step further comprises the substep of filling the cooking vessel with cooking medium, the filling substep comprises introducing cooking medium while the drain valve is closed.

4. The method of claim 1, further comprising the step of indicating that filtering of the cooking medium is being performed.

5. The method of claim 4, further comprising the step of indicating that the cooking medium is not in suitable condition for filtering.

6. The method of claim 1, wherein the requesting step comprises activating a single switch to request filtering of the cooking medium.

7. The method of claim 1, wherein:
the requesting step comprises requesting filtering of the cooking medium in each cooking vessel of a plurality of cooking vessels, and
the determining step only determines that the cooking medium in only one of the plurality of cooking vessels is in suitable condition for filtering, such that only one cooking vessel is filtered at any time.

8. The method of claim 7, further comprising repeating the filtering step on the plurality of cooking vessels until each cooking vessel is filtered.

9. A system for automatically filtering a cooking medium of a cooking apparatus, comprising:
a first cooking vessel;
a first drain valve disposed on a first fluid communication path between said first cooking vessel and a drain manifold;
a filter container fluidly connected to said drain manifold on a manifold drain path;
a fill manifold fluidly connected to said filter container on a manifold fill path;
a first fill valve disposed on a second fluid communication path between said fill manifold and said first cooking vessel;
a pump for conveying the cooking medium from said drain path to said fill path through said filter container;
a controller configured to selectively operate said first drain valve and said first fill valve to regulate a flow of cooking medium to and from said first cooking vessel; and
a single switch configured to send a control signal to said controller in response to actuating said switch.

10. The system claim 9, wherein said switch is a manually operable switch.

11. The system of claim 9, wherein said first fill valve is a solenoid actuated valve and said first drain valve is a linearly actuated valve.

12. The system of claim 11, wherein said first fill valve is fluidly connected to a first linear diffuser header comprising a plurality of inlet holes formed therein, said first linear diffuser header extends along a bottom surface of said first cooking vessel in a longitudinal direction substantially adjacent to a first sidewall of said first cooking vessel.

13. The system of claim 12, wherein said first fill valve is fluidly connected to a second linear diffuser header comprising a plurality of inlet holes formed therein, said second linear diffuser header extends along the bottom surface of said first cooking vessel in the longitudinal direction substantially adjacent to a second sidewall of said first cooking vessel.

14. The system of claim 11, wherein said first cooking vessel comprises:
a first inlet formed in a surface of a well defining said first cooking vessel proximate a first end of said cooking vessel and fluidly connected to said first fill valve; and
a second inlet formed in said surface of said first cooking vessel proximate a second end of said cooking vessel and fluidly connected to said first fill valve,
wherein said first inlet and said second inlet are laterally separated by a distance about equal to a width of said well.

15. The system of claim 14, wherein said surface comprises a bottom surface, the first and second inlets are formed proximate said bottom surface.

16. The system of claim 14, further comprising a drain formed in a bottom surface of said first cooking vessel,
wherein said bottom surface slopes towards said drain.

17. The system of claim 9, further comprising:
a second cooking vessel;
a second drain valve disposed on a third fluid communication path between said second cooking vessel and said drain manifold; and
a second fill valve disposed on a fourth fluid communication path between said fill manifold and said second cooking vessel,
wherein said controller is configured to selectively operate said second drain valve and said second fill valve to regulate a flow of cooking medium to and from said second cooking vessel.

18. The system of claim 9, wherein said filter container comprises a filter for filtering by-product from the cooking medium.

19. The system of claim 18, wherein said filter container is removably coupled to said fill and drain paths for changing the filter.

20. The system of claim 19, further comprising a locking mechanism to secure said filter container to said fill and drain paths during filtering of the cooking medium.

21. The system of claim 9, further comprising an indicator for indicating that one of the first drain valve and the first fill valve are open.

22. The system of claim 9, further comprising:
a second cooking vessel;
a second drain valve disposed on a third fluid communication path between said second cooking vessel and a second drain manifold; and
a second fill valve disposed on a fourth fluid communication path between a second fill manifold and said second cooking vessel,
wherein said controller is configured to selectively operate said second drain valve and said second fill valve to regulate a flow of cooking medium to and from said second cooking vessel.

23. The system of claim 22, further comprising:
a third cooking vessel;
a third drain valve disposed on a fifth fluid communication path between said third cooking vessel and said second drain manifold; and
a third fill valve disposed on a sixth fluid communication path between said second fill manifold and said third cooking vessel,
wherein said controller is configured to selectively operate said third drain valve and said third fill valve to regulate a flow of cooking medium to and from said third cooking vessel.

24. The system of claim 23, wherein said second drain manifold is fluidly connected to said filter container on a second manifold drain path and said second fill manifold is fluidly connected to said filter container on a second manifold fill path.

25. The system of claim 23, further comprising:
a second filter container fluidly connected to said second drain manifold on a second manifold drain path, said second filter container connected to said second fill manifold on a second manifold fill path; and
a second pump conveying the cooking medium from said second manifold drain path to said second manifold fill path through a second filter container,
wherein said pump is configured to selectively operate based on a control signal from said controller.

26. A system for automatically filtering a cooking medium of a cooking apparatus, comprising:
a cooking vessel;
a drain valve disposed on a first fluid communication path between said cooking vessel and a filter container;
a fill valve disposed on a second fluid communication path between said filter container and said cooking vessel;
a pump disposed on one of said first path and said second path for conveying the cooking medium from said first path to said second path through said filter container;
a controller configured to selectively operate said drain valve and said fill valve to regulate a flow of cooking medium to and from said cooking vessel; and
a single switch configured to send a control signal to said controller in response to actuating said switch.

27. A system for automatically filtering a cooking medium of a cooking apparatus, comprising:
a means for requesting filtering of the cooking medium;
a means for determining whether the cooking medium in a cooking vessel of the cooking apparatus is in suitable condition for filtering;
a means for filtering the cooking medium in the cooking vessel upon a determination that the cooking medium in the cooking vessel is in suitable condition for filtering, comprising:
a drain valve means for operating a drain valve for draining the cooking medium from the cooking vessel;
a fill valve means for operating a fill valve for introducing the cooking medium to the cooking vessel;
a means for draining the cooking medium for the cooking vessel;
a means for passing the cooking medium through a filter; and
an means for introducing the filtered cooking medium into the cooking vessel; and
a means for indicating one of the means for filtering is operating and the cooking medium is not suitable for filtering.
